(19) United States
(12) Patent Application Publication
(10) Pub. No.: US 2009/0221773 A1
(43) Pub. Date: Sep. 3, 2009

(54) METHODS FOR DIRECT ATTACHMENT OF POLYMERS TO DIAMOND SURFACES AND DIAMOND ARTICLES

(75) Inventors: Matthew R. Linford, Orem, UT (US); Li Yang, Provo, UT (US)

Correspondence Address: HOLLAND & HART LLP, P.O. Box 11583, 60 E. South Temple, Suite 2000, Salt Lake City, UT, 84110, US

(73) Assignee: Brigham Young University, Provo, UT (US)

(21) Appl. No.: 12/039,382

(22) Filed: Feb. 28, 2008

(51) Int. Cl. C08F 2/00

(52) U.S. Cl. 526/166; 526/194

(57) ABSTRACT

A method for forming a polymer on a substrate is disclosed. The method may include providing a substrate having a substrate surface, the substrate surface being at least partially hydrogen-terminated and reacting the substrate surface in a solution comprising at least one radical initiator and at least one monomer to form a polymer on the substrate surface. The monomer may comprise at least one of a monofunctional monomer and a polyfunctional monomer. A stationary phase for use in separation applications such as chromatography and solid-phase extraction is also disclosed. The stationary phase may include a plurality of diamond bodies and a polymeric compound covalently bonded to at least a surface portion of the plurality of diamond particles.

### BACKGROUND

Chromatography and solid-phase extraction (“SPE”) are commonly used separation techniques employed in a variety of analytical chemistry and biochemistry environments. Chromatography and SPE are often used for separation, extraction, and analyses of various constituents, or fractions, of a sample of interest. Chromatography and SPE may also be used for the preparation, purification, concentration, and clean up of samples.

Chromatography and SPE relate to any of a variety of techniques used to separate complex mixtures based on the differential affinities of the fractions of the sample for a mobile phase with which the sample flows, and a stationary phase through which the sample passes. Typically, chromatography and SPE involve the use of a stationary phase that includes a finely powdered solid adsorbent packed into a cartridge or column. A commonly-used stationary phase includes a silica-gel-based sorbent material.

Mobile phases are often solvent-based liquids, although gas chromatography typically involves the use of gaseous mobile phases. Liquid mobile phases may vary significantly in their compositions, depending on various characteristics of the sample being analyzed and on the various components sought to be extracted and/or analyzed in the sample. For example, liquid mobile phases may vary significantly in pH and solvent properties. Additionally, liquid mobile phases may vary in their compositions depending on the characteristics of the stationary phase that is being employed. Often, several different mobile phases are employed during a given chromatography or SPE procedure. Stationary phase materials may also exhibit poor stability characteristics in the presence of various mobile-phase compositions. The poor stability characteristics of stationary phase materials may limit the number of times a particular stationary phase may be reused prior to disposal, and in many cases, may entirely preclude the use of a particular stationary phase in certain chromatography and SPE procedures.

### SUMMARY

According to at least one embodiment, a method for forming a polymeric compound on a substrate may comprise providing a substrate comprising a group IV solid material, the substrate having a substrate surface. The method may also comprise bonding hydrogen to at least a portion of the substrate surface reacting the substrate surface in a solution comprising at least one radical initiator and at least one monomer to form at least one polymeric compound on the substrate surface.

According to various embodiments, a method for forming a polymeric compound on a substrate may comprise providing a substrate comprising a diamond material, the substrate having a substrate surface that is at least partially hydrogen-terminated. The method may also comprise reacting the substrate surface with at least one radical initiator to form a carbon radical on the substrate surface. Additionally, the method may comprise reacting the carbon radical on the substrate surface with at least one monomer to form at least one polymeric compound on the substrate surface.

According to certain embodiments, a stationary phase may comprise a plurality of diamond bodies, the diamond bodies being at least partially hydrogen-terminated. Additionally, at least one polymeric compound may be covalently bonded to at least a surface portion of the plurality of diamond bodies. Additionally, at least a portion of the at least one polymeric compound may be crosslinked.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an exemplary diamond particle according to at least one embodiment.

FIG. 2 is a perspective view of an exemplary diamond particle according to an additional embodiment.

FIG. 3 is a perspective view of an exemplary silicon article according to at least one embodiment.

FIG. 4 is a cross-sectional view of a portion of an exemplary substrate according to at least one embodiment.

FIG. 5 is a cross-sectional view of a portion of an exemplary substrate according to additional embodiments.

FIG. 6 is a cross-sectional view of a portion of an exemplary substrate according to additional embodiments.

FIG. 7 is a schematic side cross-sectional view of an exemplary separation apparatus according to at least one embodiment.

FIG. 8 is a flow diagram of an exemplary method for forming a polymer on a diamond substrate according to an additional embodiment.

FIG. 9 is a flow diagram of an exemplary method for forming a polymer on a diamond substrate according to an additional embodiment.

FIG. 10 is a flow diagram of an exemplary method for forming a polymer on a diamond substrate according to an additional embodiment.

FIG. 11 is a flow diagram of an exemplary method for forming a polymer on a diamond substrate according to an additional embodiment.

FIG. 12 is a flow diagram of an exemplary method for forming a polymer on a diamond substrate according to an additional embodiment.

FIG. 13 is a graph showing various film thicknesses on hydrogen-terminated silicon wafers and oxide-terminated silicon wafers as a function of divinylbenzene concentration.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

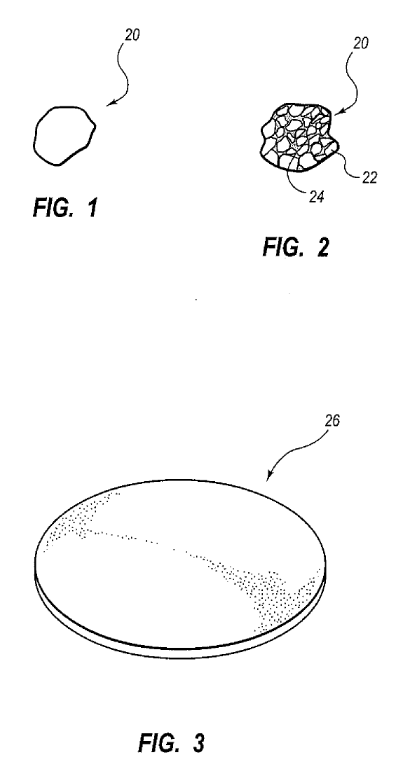

FIG. 1 is a perspective view of an exemplary diamond body 20 according to at least one embodiment. Diamond body 20 may comprise any suitable diamond material or composite diamond material. Diamond body 20 may additionally comprise carbon in various non-diamond forms, such as, for example, graphitic carbon. Diamond body 20 may also comprise one or more impurities. Diamond body 20 may be produced through any suitable means, including, for example, by forming carbonaceous material into diamond material under ultra-high pressure and high temperature conditions. Additionally, diamond body 20 may the product of natural processes or by chemical vapor deposition (“CVD”) processes.

Diamond body 20 may be formed to any suitable shape or size. For example, diamond body 20 may be produced by crushing and/or grinding a diamond starting material to obtain a desired size diamond body 20. In various embodiments, diamond body 20 may comprise a micron sized diamond particle, such as, for example, a diamond particle having a diameter of approximately 1-1000 μm. In additional embodiments, diamond body 20 may comprise a nanodiamond particle, such as, for example, a diamond particle having a diameter of approximately 1-1000 nm. Additionally, diamond body 20 may comprise a spherical or an irregular particle.

FIG. 2 shows an exemplary porous diamond body 20 formed from diamond particles 22. In at least one embodiment, diamond body 20, or a diamond material used to produce diamond body 20, may be processed to produce a porous diamond body 20. Diamond body 20 may be formed through any suitable means, including, for example, by sintering diamond particles 22 to produce a porous diamond body 20. More particularly, sintering diamond particles 22 under high temperatures and/or high pressures may cause adjacent diamond particles 22 to become coupled to one another, producing diamond body 20 having recesses 24 defined between adjoining diamond particles 22. As used herein, the terms “couple,” “coupled,” and “coupling,” may refer to any type of joining, attaching, connecting, and/or bonding, without limitation. In additional embodiments, diamond particles 22 may be coupled together through sintering or any other suitable means to produce a porous diamond mass, which may subsequently be crushed and sized into desired porous diamond bodies 20. In various embodiments, a catalyst may be used to facilitate coupling diamond particles 22 together under various conditions.

In additional embodiments, diamond body 20 may comprise polycrystalline diamond. Diamond body 20 comprising polycrystalline diamond may be formed using any suitable techniques, such as, for example, sintering diamond and/or cubic boron nitride crystal powder under high temperature and high pressure (“HPHT”) conditions. The HPHT conditions may cause diamond crystals or grains to bond to one another to form a skeleton or matrix of diamond through diamond-to-diamond bonding between adjacent diamond particles or other crystalline particles. Additionally, recesses 24 may be formed within the diamond structure due to HPHT sintering.

In various embodiments, a catalyst may be employed for facilitating formation of diamond body 20. Examples of catalysts that may be useful for forming superabrasive diamond body 20 include, without limitation, group VIII Elements (e.g., Fe, Co, Ni, Ru, Rh, Pd, Os, Ir, Pt, etc.), transition metals (e.g., Mn, Cr, Ta, etc.), carbonates (e.g., LiCO₃, NaCO₃, MgCO₃, CaCO₃, SrCO₃, K₂CO₃, etc.), sulfates (e.g., NaSO₄, MgSO₄, CaSO₄, etc.), hydrates (e.g., Mg(OH)₂, Ca(OH)₂, etc.), boron compounds (e.g., B, B₄C, etc.), iron oxides (e.g., FeTiO₃, FeSiO₄, Y₃Fe₅O₁₂, etc.), buckminsterfullerenes (e.g., fullerenes, buckyballs, etc.), TiC_{0.6}, phosphorous, copper, zinc, and/or germanium. Additional examples of catalysts include, without limitation, at least one carbide forming element from at least one of group IVB, group VB, or group VIB (e.g., Ti, Zr, Hf, V, Nb, Mo, W, etc.), alloyed with at least one element from group IB (e.g., Cu, Ag, Au, etc.).

In at least one example, a so-called solvent catalyst may be employed for facilitating the formation of diamond body 20. Examples of solvent catalysts that may be used for forming diamond body 20 include, without limitation, cobalt, nickel, and/or iron. In various examples, a solvent catalyst may dissolve carbon; for example, carbon may be dissolved from the diamond grains or portions of the diamond grains that may graphitize due to high temperature conditions existing during sintering. When a solvent catalyst is cooled, carbon held in solution during sintering may precipitate or otherwise be expelled from the solvent catalyst and may facilitate formation of diamond bonds between abutting or adjacent diamond grains. In certain embodiments, the solvent catalyst may remain in diamond body 20 within recesses 24. In additional embodiments, another material may replace the solvent catalyst that has been at least partially removed from diamond body 20.

FIG. 3 shows an exemplary article 26 according to at least one embodiment. Examples of article 26 include, without limitation, articles formed from silicon and/or germanium compounds, such as silicon wafers, semiconductor devices, and integrated circuits. Article 26 may comprise any suitable material, including, for example, silicon, silicon oxide, silicon nitride, silicon carbide, and/or any suitable silicon and/or germanium compound. Silicon article 26 may additionally comprise silicon in any other suitable form, including particle form. Additionally, silicon article 26 may be porous and/or non-porous. Article 26 may also comprise a doped silicon and/or germanium compound comprising one or more impurities. Article 26 may additionally comprise impurities introduced through means other than doping.

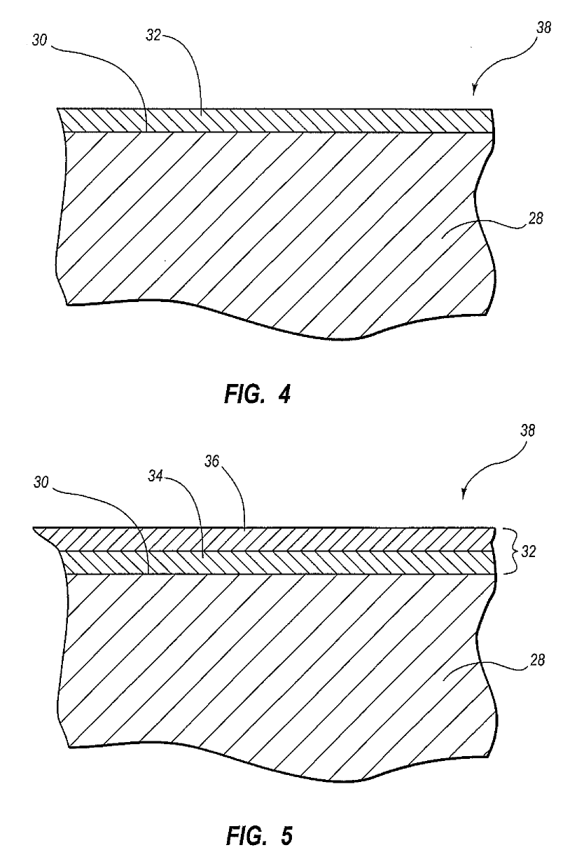

FIG. 4 shows a portion of an exemplary article 38 according to various embodiments. Article 38 may comprise any suitable article, such as, for example, diamond body 20 as shown in FIGS. 1 and 2 or an article 26 as shown in FIG. 3. Additionally, article 38 may comprise any suitable material, such as, for example, a Group IV solid material comprising a Group IV element. A Group IV solid material may comprise, for example, a suitable material formed from solid carbon, silicon, and/or germanium. A Group IV solid material may additionally comprise, without limitation, a diamond material, and/or a silicon material, including silicon oxide, silicon nitride, and/or silicon carbide. A Group IV solid material may also comprise various forms of carbon, including, for example, amorphous carbon and glassy carbon. As illustrated in FIG. 4, article 38 may comprise a substrate 28 comprising a Group IV solid material, such as a diamond material forming diamond body 20 and/or a silicon material forming a silicon article 26. At least a portion of substrate 28 may comprise a coating 32 that includes a polymeric compound. Coating 32 may be disposed on at least a portion of surface 30 of substrate 28. Additionally, coating 32 may substantially coat at least a portion of surface 30. Additionally, coating 32 may coat various discrete portions of surface 30.

Coating 32 may also be formed to various thicknesses. Additionally, coating 32 may be used to provide article 38 with various properties, including, for instance, various properties enabling article 38 to be suitably used in various chromatography and/or solid-phase extraction applications, such as reversed-phase chromatography, ion-exchange chromatography, and/or normal phase chromatography. Additionally, coating 32 may be used to provide a bonding site for additional compounds that may provide article 38 with various properties and/or characteristics. In at least one embodiment, for example, a coating 32 comprising phenyl groups may be sulfonated by exposing coating 32 to a sulfonating agent, such as a solution comprising sulphuric acid. For example, a coating 32 may be immersed in a solution of acetic acid in acetic acid and concentrated H₂SO₄.

In an additional embodiment, surface 30 of substrate 28 comprising a diamond material may include a coating 32 comprising a polymethyl methacrylate compound formed from a methyl methacryate monomer unit that may be immersed in a solution comprising NaOH in methanol. Subsequently, —COO⁻Na⁺ groups may be formed on coating 32, which may be used in an ion-exchange stationary phase.

In at least one embodiment, coating 32 may be formed from at least one polymeric compound. As used herein, the term “polymeric compound” may include oligomers and/or polymers of varying chain lengths and molecular weights, without limitation. A polymeric compound as used herein may refer to compounds formed from more than one monomer subunit, which may include macromonomers, oligomers, and/or various polymers. Coating 32 may also be formed from a combination and/or mixture of polymeric compounds. Additionally, polymers forming coating 32 may be branched and/or straight, and may additionally be saturated and/or unsaturated. In various embodiments, coating 32 may comprise, for example, a homopolymer and/or a copolymer including polystyrene, polyacrylonitrile, polymethacrylate, polyacrylamide, and/or polyacrylate.

In additional embodiments, coating 32 may comprise a homopolymer and/or a copolymer compound formed from monomer subunits. Monomer subunits may comprise, for example, any suitable monomer useful for polymerizing with additional monomers and/or polymers. A monomer subunit may additionally include any monomer suitable for use in a radical initiated polymerization reaction. In at least one embodiment, a suitable monomer may comprise at least one substituent group that allows the monomer to bond to a radical, including, for example, a vinyl group. Examples of suitable monomers include, without limitation, styrene, methyl acrylate, stearyl acrylate, methyl methacrylate, 2-hydroxyethylmethacrylate, acrylonitrile, methylacrylonitrile, acrylic acid, methacrylic monomer, acrylamide monomer, 2-isocyanatoethyl methacrylate, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, 2-(tert-butylamino)ethyl methacrylate, 1,3-butadiene, isoprene, vinyl chloride, butyl acrylate, dodecyl methacrylate, 4-vinylbenzyl chloride, maleimide, maleic anhydride, 4-(trifluoromethyl)styrene, 3-nitrostyrene, vinyl ether, and/or vinyl acetate.

In various embodiments, coating 32 may comprise a polymeric compound having various chain lengths. For example, a polymeric composition in coating 32 may comprise various molecular weights based on a molecular weight of a polymer chain coupled to article 38 and/or segments of a crosslinked polymer chain as measured between branching points of a crosslinked polymer. For instance, coating 32 may comprise a polymeric compound having a weight-average molecular weight or number-average molecular weight ranging from approximately 1,000 to approximately 1,000,000. In certain embodiments, coating 32 may comprise a polymeric compound having a weight-average molecular weight or number-average molecular weight ranging from approximately 5,000 to approximately 100,000. Additionally, coating 32 may comprise a polymeric compound having a weight-average molecular weight or number-average molecular weight ranging from approximately 30,000 to approximately 60,000 monomer units. In additional embodiments, coating 32 may comprise polymeric compound having a weight-average molecular weight or number-average molecular weight of less then approximately 1,000. Coating 32 may optionally comprise oligomers having a chain length of from 2 to 100 monomer units in length. Additionally, coating 32 may comprise a polymeric compound having a weight-average molecular weight or number-average molecular weight greater than 1,000,000, such as, for example, where the polymeric compound is substantially crosslinked.

In various embodiments, coating 32 and/or at least a compound forming coating 32 may be cured and/or crosslinked to increase a stability of coating 32. For example, coating 32 may be thermally cured by exposing coating 32 to an elevated temperature. In an additional embodiment, coating 32 may be exposed to a pressure that is higher or lower than an ambient atmospheric pressure to effect curing of coating 32 and/or at least a compound forming coating 32. Curing may increase the physical and/or chemical stability of coating 32. For example, curing may increase the stability of coating 32 when coating 32 is exposed to high and/or or low pH solutions.

Coating 32 and/or at least a polymeric compound forming coating 32 may be crosslinked through any suitable method, without limitation. For example, a crosslinking agent may be combined with coating 32 during and/or after formation of coating 32 on at least a portion of surface 30 of substrate 28. Additionally, a crosslinking agent may be combined with a composition forming coating 32 prior to depositing the composition on at least a portion of surface 30 of substrate 28. In additional embodiments, coating 32 and/or at least a polymeric compound forming coating 32 may be crosslinked during a curing process, such as a thermal and/or pressure induced curing process, as described above. Additionally, coating 32 and/or at least a polymeric compound forming coating 32 may be crosslinked by exposing coating 32 to radiation.

In certain embodiments, a polyfunctional monomer may be used to form a crosslinked portion of coating 32. A polyfunctional monomer may comprise a monomer having at least two functional bonding sites, such as, for example, a bi-, tri-, tetra-, and/or penta-functional monomer. For example, a polyfunctional monomer may comprise a compound having at least two terminal vinyl groups, each of which may bond with a radical group. A polyfunctional monomer may bond with a terminal radical group on at least two or more monomer and/or polymer compounds, including, for example, monofunctional and/or polyfunctional monomer units. Additionally, a polyfunctional monomer may bond with a terminal radical group on a monomer and/or polymer molecule and a terminal radical group on surface 30 of substrate 28. In an additional embodiment, a polyfunctional monomer may bond with at least one terminal radical group on at least two separate sites on a single polymeric molecule.

Examples of polyfunctional monomers suitable for forming a crosslinked coating 32 and/or a crosslinked polymeric compound forming at least a portion of coating 32 include, without limitation, divinylbenzene, 1,3-butanediol diacrylate, 1,4-butanediol diacrylate, pentaerythritol triacrylate, pentaerythritol tetraacrylate, dipentaerythritol pentaacrylate, 1,6-hexanediol dimethacrylate, and/or propoxylated (3) glyceryl triacrylate

Article 38 comprising substrate 28 including a diamond material (see e.g., FIGS. 1 and 2) and/or a silicon material (see e.g., FIG. 3) may be at least partially hydrogen-terminated prior to formation of a radical on substrate 28. As used herein, the term “hydrogen-terminated” may refer to a process of bonding at least one hydrogen atom to a surface, article, body, compound, and/or substrate, and/or may describe a surface, article, body, compound, and/or substrate to which at least one hydrogen atom is bonded, without limitation. Surface 30 of a substrate 28 comprising a diamond material may be at least partially hydrogen-terminated through any suitable means, including, for example, thermal and/or plasma treatments. In various embodiments, surface 30 of substrate 28 comprising a diamond material may be hydrogen-terminated by exposing substrate 28 to a gas comprising hydrogen. In at least one embodiment, surface 30 may be hydrogen-terminated by exposing substrate 28 to a gas comprising hydrogen at an elevated temperature. Additionally, substrate 28 may be exposed to a gas comprising a deuterium isotope of hydrogen. In an additional embodiment, surface 30 of substrate 28 comprising a silicon material may be hydrogen-terminated, for example, by etching the silicon material (e.g., with a fluoride ion etch).

Coating 32 may be formed using any suitable method. According to at least one embodiment, coating 32 may be formed by forming a radical on substrate 28. A radical may be formed on substrate 28 through various means, including, for example, by using a radical initiator to abstract a hydrogen atom from surface 30 to form a carbon-centered radical on a diamond material and/or a silicon-centered radical on a silicon based material. Examples of suitable radical initiators include, without limitation, di-tert-amylperoxide, benzoylperoxide, t-butylhydroperoxide, and/or azobisisobutyronitrile. Additionally, a radical initiator may comprise various substituted azonitrile compounds including, without limitation, commercially available substituted azonitrile compounds sold under the names VAZO 52®, VAZO 64®, VAZO 67®, VAZO 88®, VAZO 56®, and/or VAZO 68® (DuPont Corporation). In various embodiments, a radical initiator may be decomposed prior to abstracting a hydrogen atom from surface 30. Decomposition of a radical initiator may be accomplished through any suitable means, including, for example, by heating the radical initiator to form an oxygen-centered radical species, and/or by exposure of the radical initiator to light, such as UV light. Additionally, in various embodiments, light, such as UV light, may be used as a type of radical initiator used to form a radical directly on surface 30. According to at least one embodiment, due to the strength of an O—H bond on an oxygen-centered radical species formed from a peroxide in comparison with, for example, a C—H bond on a surface of hydrogen-terminated diamond, an oxygen-centered radical species may effectively abstract a hydrogen from a hydrogen-terminated surface, leaving a radical on the surface.

Following formation of a radical on surface 30 of substrate 28, a monomer and/or a polymer may be reacted with the radical to form a covalent bond on surface 30 at the site of the radical. Additionally, a radical formed on surface 30 may be used to initiate polymerization of at least one monomer to form a polymer compound. In at least one embodiment, when a first monomer forms a bond at a site of a radical on surface 30, a radical may be formed at a terminal end of the first monomer. Subsequently, a second monomer may then form a bond at the site of the radical at the terminal end of the first monomer, after which a radical may be formed at a terminal end of the second monomer. Additional monomers may subsequently be attached successively to create a polymer chain bonded to surface 30. Coating 32 may comprise straight, branched, and/or crosslinked polymer chains bonded to surface 30.

In various embodiments, a monomer, a macromonomer, and/or a polymer comprising a functional group, such as, for example, a vinyl group, may be bonded to substrate 28 at the site of a radical on surface 30. Various monomers and/or combinations of monomers may be used to form a polymer on substrate 28, such as, for example, a homopolymer and/or a copolymer compound formed from monomer subunits including, for example, styrene, methyl acrylate, stearyl acrylate, methyl methacrylate, 2-hydroxyethylmethacrylate, acrylonitrile, methylacrylonitrile, acrylic acid, methacrylic monomer, acrylamide monomer, 2-isocyanatoethyl methacrylate, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, 2-(tert-butylamino)ethyl methacrylate, 1,3-butadiene, isoprene, vinyl chloride, butyl acrylate, dodecyl methacrylate, 4-vinylbenzyl chloride, maleimide, maleic anhydride, 4-(trifluoromethyl)styrene, 3-nitrostyrene, vinyl ether, and/or vinyl acetate. In at least one embodiment, substrate 28 may be immersed in a solution comprising a radical initiator to form a radical on surface 30.

Additionally, substrate 28 may be immersed in a solution comprising a monomer and/or a polymer to bond the monomer and/or the polymer to surface 30 and/or to effect radical-initiated polymerization on surface 30, thereby forming a polymer that is bonded to surface 30. Substrate 28 may also be immersed in a solution comprising a monomer capable of forming crosslinked polymeric compounds on surface 30, such as a polyfunctional monomer, including, for example, divinylbenzene, 1,3-butanediol diacrylate, 1,4-butanediol diacrylate, pentaerythritol triacrylate, pentaerythritol tetraacrylate, dipentaerythritol pentaacrylate, 1,6-hexanediol dimethacrylate, and/or propoxylated (3) glyceryl triacrylate.

In certain embodiments, substrate 30 may be immersed in different solutions to form coating 32. For example, a first solution may comprise a radical initiator and a second solution may comprise a monomer and/or a polymer. In additional embodiments, a single solution may be used to form coating 32. For example, a solution may comprise a radical initiator, a monomer and/or a polymer. The use of a single solution to form coating 32 may be advantageous due to the ability to form coating 32 in a single step, simplifying a coating procedure. For example, a radical may be formed on surface 30 and a polymer may additionally be formed on the polymer by immersing article 38 in a single solution. Additionally, a single solution may, for example, enhance formation of a polymer on surface 30 by preventing oxygen-centered radical species from becoming tethered to surface 30 at the site of a radical species on surface 30, instead of various monomer and/or polymers, as might occur in a solution containing a radical initiator without a monomer or polymer. In an additional embodiment, a single solution containing a radical initiator, a monomer and/or a polymer may allow formation of a coating 32 that has a relatively greater thickness due to the presence of polyfunctional monomers during the formation of a polymer forming coating 32.

FIG. 5 shows a portion of an exemplary article 38 according to certain embodiments. As illustrated in this figure, article 38 may comprise a coating 32 disposed on at least a portion of surface 30 of substrate 28. In at least one embodiment, coating 32 may comprise two or more coating layers. For example, as shown in FIG. 5, coating 32 may comprise a first coating layer 34 and a second coating layer 36. First coating layer 34 may be disposed on at least a portion of surface 30 of substrate 28. First coating layer 34 may be disposed upon at least a portion of surface 30. Additionally, first coating layer 34 may be disposed upon various selected portions of surface 30. First coating layer 34 may also be formed to various thicknesses.

First coating layer 34 may provide a bonding site for second coating layer 36 and/or various compounds present within second coating layer 36. In at least one embodiment, first coating layer 34 may comprise at least one polymeric compound. First coating layer 34 may also comprise a combination and/or mixture of polymeric compounds. In at least one embodiment, first coating layer 34 may be formed from at least one polymeric compound. First coating layer 34 may also be formed from a combination and/or mixture of polymeric compounds. In various embodiments, first coating layer 34 may comprise, for example, a homopolymer and/or a copolymer including polystyrene, polyacrylonitrile, polymethacrylate, polyacrylamide, and/or polyacrylate.

In additional embodiments, first coating layer 34 may comprise a homopolymer and/or a copolymer compound formed from monomer subunits including, for example, styrene, methyl acrylate, stearyl acrylate, methyl methacrylate, 2-hydroxyethylmethacrylate, acrylonitrile, methylacrylonitrile, acrylic acid, methacrylic monomer, acrylamide monomer, 2-isocyanatoethyl methaerylate, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, 2-(tert-butylamino)ethyl methacrylate, 1,3-butadiene, isoprene, vinyl chloride, butyl acrylate, dodecyl methacrylate, 4-vinylbenzyl chloride, maleimide, maleic anhydride, 4-(trifluoromethyl)styrene, 3-nitrostyrene, vinyl ether, and/or vinyl acetate.

Second coating layer 36 may comprise additional compounds disposed on and/or coupled to first coating layer 34. Various compounds in second coating layer 36 may impart certain properties to article 38, enabling article 38 to be suitably used, for example, in various chromatography and/or solid-phase extraction applications. Additionally, second coating layer 36 may provide a bonding site for additional compounds that may provide article 38 with additional characteristics. Second coating layer 36 may substantially coat at least a portion of first coating layer 34. Additionally, second coating layer 36 may coat various distinct portions of first coating 42 and/or surface 30 of substrate 28. In various embodiments, second coating layer 36 may be formed using at least a solution comprising compounds used to form first coating layer 34. In additional embodiments, second coating layer 36 may formed using at least a solution comprising compounds other than those used to form first coating layer 34.

In an additional embodiment, first coating layer 34 may comprise a polymethyl methacrylate compound that may be reacted with a compound having a pendant an alkyl Grignard reagent of varying chain lengths and/or an alkyl lithium reagent, such as butyl-, octyl-, or octadecyllithium (C_{4,8,18}Li) to produce a diamond powder functionalized with alkyl groups forming second coating layer 36. A diamond powder comprising diamond bodies 20 having a second coating layer 36 including alkyl chains of different lengths may be used as a reverse-phase column stationary phase.

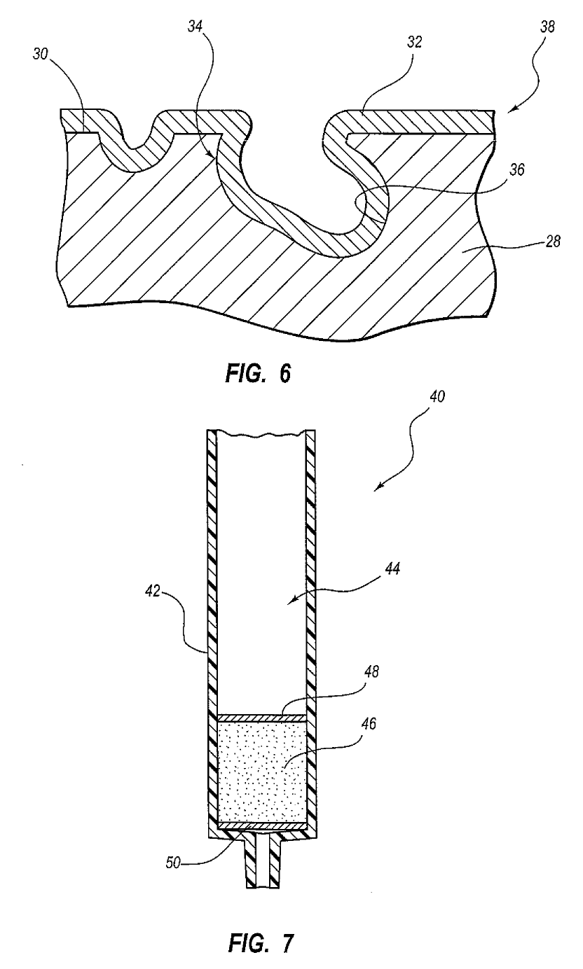

FIG. 6 shows a portion of an exemplary article 38 according to additional embodiments. As illustrated in this figure, article 38 may comprise a substrate 28 comprising a diamond material. Additionally, at least a portion of article 38 may comprise a coating 32 comprising a polymeric compound. Coating 32 may be formed on at least a portion of a surface 30 of substrate 28. In addition, substrate 28 may comprise at least one recess 34 defined by recess surface 36 in a portion of substrate 28. Recess 34 may be formed by any suitable method (see e.g., FIG. 2). In at least one embodiment, recess 34 may comprise a space defined between adjacent and/or coupled diamond fragments 21, as shown in FIG. 2.

As shown in FIG. 6, recess 34 may be located on an outer portion of substrate 28 such that recess 34 is open to an exterior of substrate 28. Recess 34 may extend through at least a portion of article 38 and may be connected to additional recesses 28. Additionally, coating 32 may be formed on at least a portion of recess surface 36 defining recess 34. An article 38 comprising recess 34 may have a greater exposed surface area in comparison with an article 38 that does not have a recess. In other words, surface 29 defining recess 34 may provide article 38 with additional surface area that is exposed to an exterior of article 38.

FIG. 7 shows an exemplary separation apparatus 40 according to at least one embodiment. As illustrated in this figure, separation apparatus 40 may comprise a column 42 defining a reservoir 44. Additionally, a stationary phase 46 may be disposed within at least a portion of reservoir 44 of column 42. Stationary phase 46 may comprise a plurality of diamond bodies 20. As described above with reference to FIGS. 4-6, diamond bodies 20 may be at least partially coated with a polymeric coating, such as coating 32 on article 38. Additionally, diamond bodies 20 may be porous, comprising recesses on their surface, such as, for example, recess 24 shown in FIG. 3 and/or recess 34 shown in FIG. 6. In various embodiments, a frit 48 and/or a frit 50 may be disposed in column 42 on either side of stationary phase 46. Frits 48 and 50 may comprise any suitable material that allows passage of a mobile phase and any solutes present in the mobile phase, while preventing passage of diamond bodies 20 present in stationary phase 46. Examples of materials used to form frits 48 and 50 include, without limitation, glass, polypropylene, polyethylene, stainless steel, and/or polytetrafluoroethylene.

Column 42 may comprise any type of column or other device suitable for use in separation processes such as chromatography and solid-phase extraction processes. Examples of column 42 include, without limitation, chromatographic and solid-phase extraction columns, tubes, syringes, cartridges (e.g., in-line cartridges), and plates containing multiple extraction wells (e.g., 96-well plates). Reservoir 44 may be defined within an interior portion of column 42. Reservoir 44 may permit passage of various materials, including various solutions and solvents used in chromatographic and solid-phase extraction processes.

Stationary phase 46 may be disposed within at least a portion of reservoir 44 of column 42 so that various solutions and solvents introduced into column 42 contact at least a portion of stationary phase 46. Stationary phase 46 may comprise a plurality of diamond bodies 20 that are substantially non-porous (see e.g., FIG. 1). In additional embodiments, stationary phase 46 may comprise a plurality of diamond bodies 20 that are substantially porous (see e.g., FIGS. 2 and 6). A stationary phase 46 comprising diamond bodies 20 that are substantially porous may have a greater contact surface area in comparison with an equal volume and/or weight of a stationary phase 46 comprising diamond bodies 20 that are relatively less-porous and/or non-porous. In certain embodiments, frits, such as glass frits, may be positioned within reservoir 44 to hold stationary phase 46 in place, while allowing passage of various materials such as solutions and solvents. Additionally, a stationary phase 46 comprising diamond bodies 20, comprising a covalently bonded coating as described above, may exhibit increased stability characteristics in various solutions in comparison with a stationary phase formed from various other materials, such as, for example, a stationary phase comprising silica gel.

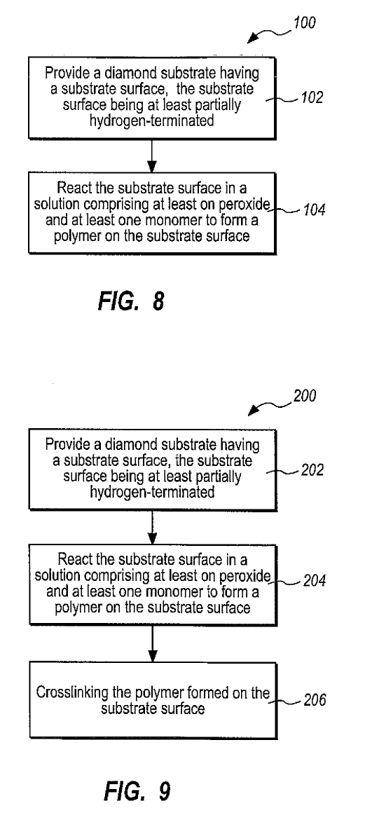

FIGS. 8-11 show various exemplary methods for forming a polymer on a diamond substrate according various embodiments. FIG. 8 is a flow diagram of an exemplary method 100 for forming a polymeric compound on a substrate according to at least one embodiment. As illustrated in this figure, at step 102, a substrate having a substrate surface may be provided. The substrate surface may be at least partially hydrogen-terminated. The substrate may comprise at least a portion of an article, such as, for example diamond body 20 shown in FIGS. 1-2 or article 26 shown in FIG. 3. Additionally, the substrate may comprise any suitable material, such as, for example, a Group IV solid material. A Group IV solid material may comprise, for example, a suitable material formed from solid carbon, silicon, and/or germanium. A Group IV solid material may additionally comprise, without limitation, a diamond material, and/or a silicon material including silicon oxide, silicon nitride, and/or silicon carbide. In various embodiments, the substrate surface may be at least partially deuterium-terminated.

In additional embodiments, at step 104, the substrate surface may be reacted in a solution comprising at least one radical initiator and at least one monomer to form a polymer on the substrate surface (see e.g., FIGS. 4-6). For example, the substrate surface may be immersed in a solution comprising one radical initiator and at least one monomer. The at least one radical initiator may comprise any suitable compound that may form a radical on the substrate surface. In additional embodiments, the at least one radical initiator may abstract a hydrogen from the substrate surface to form a radical on the substrate surface. The at least one monomer may comprise a monofunctional and/or a polyfunctional monomer. In various embodiments, the polymer may become covalently bonded to the substrate surface during step 104. The polymer may be formed from the at least one monomer through any suitable polymerization mechanism, including, for example, a radical-initiated polymerization mechanism, during step 104. Additionally, the at least one radical initiator may be decomposed prior to or during step 104. For example, the at least one radical initiator may be decomposed through heat or any other suitable means to form an oxygen-centered radical species.

FIG. 9 is a flow diagram of an exemplary method 200 for forming a polymeric compound on a substrate according to at least one embodiment. As illustrated in this figure, at step 202, a substrate having a substrate surface may be provided. The substrate surface may be at least partially hydrogen-terminated. At step 204, the substrate surface may be reacted in a solution comprising at least one radical initiator and at least one monomer to form a polymer on the substrate surface.

At step 206, the polymer formed on the substrate surface may be crosslinked. The polymer may be crosslinked with itself or with other compounds present on the substrate surface using any suitable technique, without limitation. For example, a polyfunctional monomer may be present in the solution, forming a crosslinked polymer as the polymer is formed on the substrate surface from the at least one monomer. A polyfunctional monomer may become bonded with other polyfunctional monomers and/or monofunctional monomers. A polyfunctional monomer may additionally become bonded with various polymeric compounds in the coating, and/or may become bonded with a portion of the substrate surface.

In an additional embodiment, a crosslinking agent may be present in the solution. Additionally, the substrate surface may be combined with a crosslinking agent after removing the substrate surface from the solution comprising the at least one radical initiator and the at least one monomer. In additional embodiments, the polymer may be crosslinked during a curing process, such as a thermal and/or pressure-induced curing process. Additionally, the polymer may be crosslinked by exposing the polymer to radiation.

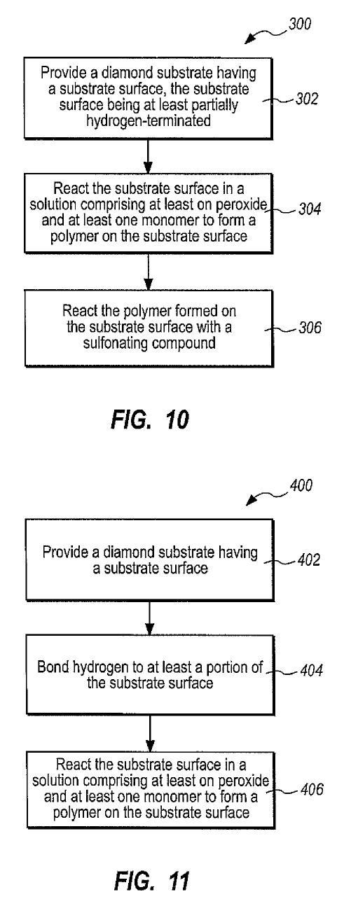

FIG. 10 is a flow diagram of an exemplary method 300 for forming a polymeric compound on a substrate according to at least one embodiment. As illustrated in this figure, at step 302, a substrate having a substrate surface may be provided. The substrate surface may be at least partially hydrogen-terminated. At step 304, the substrate surface may be reacted in a solution comprising at least one radical initiator and at least one monomer to form a polymer on the substrate surface. At step 306, the polymer formed on the substrate surface may be reacted with a second compound. In at least one embodiment, for example, the polymer formed on the substrate surface may be sulfonated by exposing the polymer to a sulfonating compound or agent, such as, for example, sulphuric acid.

FIG. 11 is a flow diagram of an exemplary method 400 for forming a polymeric compound on a substrate according to at least one embodiment. As illustrated in this figure, at step 402, a substrate having a substrate surface may be provided. At step 404, hydrogen may be bonded to at least a portion of the substrate surface. The hydrogen may be bonded to the substrate surface using any suitable technique, such as, for example, by exposing the substrate surface to a gas comprising hydrogen. The substrate surface may additionally be exposed to the gas comprising hydrogen at an elevated temperature, facilitating attachment of hydrogen to the substrate surface. In various embodiments, the gas may comprise deuterium. At step 406, the substrate surface may be reacted in a solution comprising at least one radical initiator and at least one monomer to form a polymer on the substrate surface.

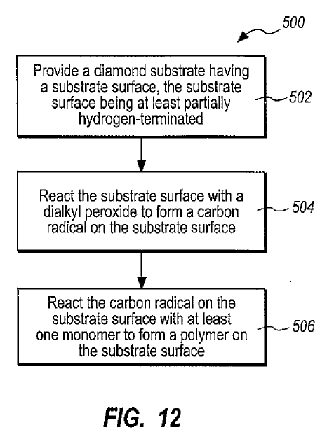

FIG. 12 is a flow diagram of an exemplary method 500 for forming a polymeric compound on a substrate according to at least one embodiment. As illustrated in this figure, at step 502, a substrate having a substrate surface may be provided. The substrate surface may be at least partially hydrogen-terminated. At step 504, the substrate surface may be reacted with a radical initiator to form a carbon radical on the substrate surface. A radical may be formed on the substrate surface through various means, including, for example, by using a radical initiator to abstract a hydrogen atom from the substrate surface, thereby forming a radical, such as, for example, a carbon-centered radical on the substrate surface. In various embodiments, a radical initiator may be decomposed to form an oxygen-centered radical species prior to abstracting a hydrogen atom from the substrate surface. An oxygen-centered radical species may effectively abstract a hydrogen from the hydrogen-terminated substrate surface, leaving a radical on the substrate surface.

At step 506, the carbon radical on the substrate surface may be reacted with the at least one monomer to form a polymer on the substrate surface. Following formation of a radical on the substrate surface, a monomer be may be reacted with the radical to form a covalent bond on the substrate surface at the site of the radical. Additionally, a radical formed on the substrate surface may be used to initiate polymerization of at least one monomer to form a polymer compound.

### EXAMPLES

The following examples are for illustrative purposes only and are not meant to be limiting with regards to the scope of the specification or the appended claims.

### Reagents

Reagents used in the following examples include: chloroform (Aldrich, spectra grade); Di-tert-amyl peroxide (Aldrich, 97%); dicumyl peroxide (Aldrich, 98%); methyl methacrylate (Aldrich, 99%, inhibited with 10-100 ppm monomethyl ether hydroquinone (MEHQ)); styrene (Spectrum, 99%, inhibited with 50 ppm p-tert-butylcatechol); divinylbenzene (Aldrich, 80%, remainder mostly 3- and 4-ethyl vinyl benzene, inhibited with 1000 ppm p-tert-butylcatechol); methyl acrylate (Aldrich, 99%, inhibited with 100 ppm MEHQ); 1,3-butanedioldiacrylate (Aldrich, 98%, inhibited with 500 ppm hydroquinone), benzoyl peroxide (Aldrich, 97%). All mixture gases, including 5% deuterium in argon (99.999% pure), were purchased from Airgas Inc.

All monomers used in the following examples were passed through an inhibitor-removing column to remove polymerization inhibitors prior to use. The adsorbants for removing MEHQ and tert-butylcatechol were obtained from Aldrich.

### Substrates

Untreated diamond powder having an average diameter of 2 μm was purchased commercially. Silicon wafer substrates used in the following examples included silicon wafer substrates (test grade, n-type, <1-0-0> orientation, 2-6 Ω-cm, UniSil Corporation, California) that were cleaved into ca. 1.5×1.5 cm pieces.

### Instrumentation for Characterization of Surfaces

Time-of-flight secondary ion mass spectrometry (“ToF-SIMS”) was performed with an ION-TOF ToF-SIMS IV instrument using monoisotopic 25 keV ⁶⁹Ga⁺ ions.

X-ray photoelectron spectroscopy (“XPS”) was performed with an SSX-100 X-ray photoelectron spectrometer with a monochromatic Al K_{α} source and a hemispherical analyzer. An electron flood gun was employed for charge compensation. Survey scans as well as narrow scans were recorded with an 800×800 μm spot.

Diamond surfaces were characterized by diffuse reflectance infrared Fourier transform (“DRIFT”) spectroscopy (JASCO FT/IR-700). The DRIFT spectra were obtained over the range of 4000-400 cm⁻¹. For each spectrum, 64 scans were collected at a resolution of 4 cm⁻¹. The diffuse reflectance was converted into Kubelka-Munk function units.

Film thicknesses of polymers on silicon surfaces were measured with spectroscopic ellipsometry (J. A. Woollam Co., Inc., M-2000). The angles of incidence for each measurement in the following examples were 70°, 75° and 80°. Each ellipsometric thickness given in the tables herein is an average of measurements from multiple silicon surfaces that were immersed in a given solution.

### Example 1

### Preparation of Deuterium-Terminated Diamond Powder

Diamond powder was washed with a mixed acid (H₂SO₄+HNO₃) at 80° C. for 4 hour and then rinsed with distilled water and dried. The dried diamond powder was then treated in flowing 5% D₂ (in Ar) gas at 900° C. for 28 hours in a Mini-Mite Tube Furnace of Lindberg/Blue M (model number TF55030A-1, Thermo Electron Corporation). During the treatment with 5% D₂ gas, the diamond powder was shaken twice to evenly deuterate the surface. The diamond powder was then cooled in flowing 5% D₂ (in Ar).

### Example 2

### Treatment of Deuterium-Terminated Diamond Powder with Di-tert-amyl Peroxide

0.5 g of deuterium terminated diamond powder prepared according to Example 1 was suspended in 5 mL of neat di-tert-amyl peroxide. Nitrogen gas was bubbled through the suspension to remove oxygen. Di-tert-amyl peroxide is a colorless liquid with a half-life at 123.3° C. of 10 hr and at 143.1° C. of 1 hr. The suspension was maintained at 130° C. for 24 hrs during this process. During this time, neat di-tert-amyl peroxide was added a second time to replace neat di-tert-amyl peroxide that was consumed. The diamond powder was then washed with chloroform and dried in a vacuum dryer.

### Example 3

### Treatment of Deuterium-Terminated Diamond Powder with Dicumyl Peroxide

0.5 g of deuterium terminated diamond powder prepared according to Example 1 was suspended in 5 g of neat dicumyl peroxide. Nitrogen gas was bubbled through the suspension to remove oxygen. Dicumyl peroxide is a white solid with a half-life at 117.1° C. of 10 hr and at 137° C. of 1 hr. The suspension was maintained at 130° C. for 24 hrs during this process. During this time, neat dicumyl peroxide was added a second time to replace neat dicumyl peroxide that was consumed. The diamond powder was then washed with chloroform and dried in a vacuum dryer.

### Surface Analysis of Untreated Deuterium-Terminated, and Peroxide Treated Diamond Powders

An obvious oxygen signal was present in an X-ray photoelectron spectroscopy (“XPS”) survey spectrum for clean, untreated diamond powder (see Table 1). This oxygen signal was presumably due to oxidized carbon at the diamond surface. XPS of deuterium terminated diamond powder prepared according to Example 1 showed a significantly lower oxygen signal in comparison with the clean, untreated diamond powder (see Table 1).

XPS of diamond powder treated with di-tert-amyl peroxide according to Example 2 and diamond powder treated with dicumyl peroxide according to Example 3 showed a higher oxygen signal in comparison with the deuterium terminated diamond powder prepared according to Example 1 (see Table 1). This increase in surface oxygen is consistent with the chemisorption of radicals and the atomic compositions of the surfaces.

TABLE 1
Examples 1-3; Concentrations of Surfaces

| Example | Composition | % C | % O |
|---|---|---|---|
| | Raw diamond powder | 89.87 ± 0.39 | 10.13 ± 0.39 |
| 1 | Deuterium-terminated diamond powder | 99.10 ± 0.05 | 0.90 ± 0.05 |
| 2 | Deuterium-terminated diamond powder reacted | 96.87 ± 0.57 | 3.13 ± 0.57 |
| | with di-tert-amyl peroxide | | |
| 3 | Deuterium-terminated diamond powder reacted | 95.54 ± 0.56 | 4.46 ± 0.56 |
| | with dicumyl peroxide | | |

Time-of-flight secondary ion mass spectrometry (“ToF-SIMS”) of clean, untreated diamond powder showed numerous hydrocarbon peaks such as C₂H₃⁺, C₂H₅⁺, C₃H₃⁺, C₃H₅⁺, C₃H₇⁺, C₃H₉⁺, C₄H₇⁺, C₄H₉⁺, C₅H₉⁺, and C₅H₁₁⁺.

ToF-SIMS of deuterium-terminated diamond powder prepared according to Example 1 showed a substantially lower total ion yield and a substantially lower intensity of hydrocarbon peaks in the positive spectrum in comparison with clean, untreated diamond powder. ToF-SIMS of deuterium-terminated diamond powder prepared according to Example 1 also showed D⁺ and D⁻ signals in the positive and negative ion spectra, respectively, and peaks for other species, such as C⁻, CD⁻, C₂⁻ and C₂D⁻, in the negative spectrum.

ToF-SIMS of diamond powder treated with di-tert-amyl peroxide according to Example 2 and diamond powder treated with dicumyl peroxide according to Example 3 showed substantially lower D⁻, CD⁻ and C₂D⁻ peaks and substantially higher H⁻ peaks in comparison with deuterium-terminated diamond powder prepared according to Example 2. Additionally, ToF-SIMS of diamond powder treated with di-tert-amyl peroxide according to Example 2 and diamond powder treated with dicumyl peroxide according to Example 3 showed that hydrocarbon peaks, such as C₂H₃⁺, C₂H₅⁺, C₃H₃⁺, C₃H₅⁺, C₃H₇⁺, C₃H₉⁺, C₄H₇⁺, C₄H₉⁺, C₅H₉⁺, and C₅H₁₁⁺, which were all from a tertiary amyl group, were higher in comparison with deuterium-terminated diamond powder prepared according to Example 2. These results demonstrate that the diamond powder treated with di-tert-amyl peroxide according to Example 2 did react with di-tert-amyl peroxide, and the diamond powder treated with dicumyl peroxide according to Example 3 did react with dicumyl peroxide.

ToF-SIMS sample spectra for diamond powder treated with dicumyl peroxide according to Example 3 were similar to ToF-SIMS sample spectra for a diamond powder treated with di-tert-amyl peroxide according to Example 3, except for three peaks at 77, 91, and 105 that were present in the positive-ion spectrum for diamond powder treated with dicumyl peroxide but not in the positive-ion spectrum for diamond powder treated with di-tert-amyl peroxide. These three peaks were assigned as C₆H₅⁺, C₇H₇⁺, and C₈H₉⁺, which are all from a phenyl group. These results are consistent with expected chemical reactivity between deuterium-terminated diamond surfaces and dicumyl peroxide, including the introduction of phenyl groups onto diamond surfaces.

Diffuse reflectance infrared Fourier transform (“DRIFT”) spectroscopy for clean, untreated diamond powder showed peaks in the absorbance spectrum at 2800-3000 cm⁻¹ that were assigned to C—H stretches. The peaks assigned to C—H stretches were most likely due to adventitious contamination of the surface.

DRIFT spectroscopy of deuterium-terminated diamond powder prepared according to Example 1 showed no C—H stretches in the absorbance spectrum, indicating that the oxidized diamond surface were likely deoxygenized and C—D bonds were likely formed on the diamond surfaces.

DRIFT spectroscopy of diamond powder treated with di-tert-amyl peroxide according to Example 2 showed envelopes of C—H stretches in the absorbance spectrum, as well as three peaks in the absorbance spectrum at 1360 and 1460 cm⁻¹ that were assigned to the tertiary amyl group. A comparison to an absorbance spectrum for pure di-tert-amyl peroxide indicated that the envelopes of C—H stretches in the absorbance spectrum for diamond powder treated with di-tert-amyl peroxide were very similar to envelopes of C—H stretches found in pure di-tert-amyl peroxide. Additionally, the absorbance spectrum for pure di-tert-amyl peroxide also showed three peaks at 1360 and 1460 cm⁻¹ assigned to the tertiary butyl group.

DRIFT spectroscopy of diamond powder treated with dicumyl peroxide according to Example 3 showed similar C—H stretches to the diamond powder treated with di-tert-amyl peroxide according to Example 2, as discussed above. Additionally, DRIFT spectroscopy of the diamond powder treated with dicumyl peroxide showed a small peak in the absorbance spectrum at 3070 cm⁻¹ that was attributed to a stretching vibration mode of C—H bonds of a phenyl group. In contrast, DRIFT spectroscopy did not show a peak in the absorbance spectrum at 3070 cm⁻¹ for either clean, untreated diamond surfaces or diamond surfaces reacted with di-tert-amyl peroxide. DRIFT spectroscopy of the diamond powder treated with dicumyl peroxide also showed three peaks in the absorbance spectrum at 1360 and 1460 cm⁻¹ that were similar to the diamond surfaces reacted with di-tert-amyl peroxide and assigned to the tertiary butyl group, although these peaks are not very significant. Further, DRIFT spectroscopy of the diamond powder treated with dicumyl peroxide showed peaks in the absorbance spectrum in the 1000-1200 cm⁻¹ region that were attributed to an ester linkage. In addition, DRIFT spectroscopy of the diamond powder treated with dicumyl peroxide showed two peaks in the absorbance spectrum at 700 and 800 cm⁻¹ that were assigned to the mono-benzene groups, which is consistent with absorbance IR of pure dicumyl peroxide.

These results indicate that a free-radical substitution reaction occurred on the diamond surfaces of the diamond treated with di-tert-amyl peroxide according to Example 2 and the diamond powder treated with dicumyl peroxide according to Example 3 because of the abstraction of deuterium atoms from the diamond surface by the radical species derived from di-tert-amyl peroxide and/or dicumyl peroxide.

### Example 4

### Treatment of Deuterium-Terminated Diamond Powder with Di-tert-amyl Peroxide and Styrene

A solution including 0.05M Di-tert-amyl peroxide and 0.75M styrene in toluene was prepared. The solution was bubbled with nitrogen for 30 minutes, after which 0.5 g of deuterium-terminated diamond powder prepared according to Example 1 was introduced to the solution. Toluene may be used as a suitable solvent for radical polymerizations because of its small-chain transfer constant. Following introduction of the deuterium-terminated diamond powder, the temperature of the solution was raised to 110° C. The solution was maintained at 110° C. for 24 hours with stirring under a reflux condenser, and continuously purged with a gentle stream of nitrogen gas over the surface of the solution. The diamond powder was then removed from the solution, sonicated with toluene for ten minutes, and then filtered. The sonication and filtering procedure was repeated five additional times. The diamond powder was then dried in a vacuum oven.

### Example 5

### Treatment of Deuterium-Terminated Diamond Powder with Styrene

The procedure described for Example 4 was essentially followed, with the exception that a solution including 0.75M styrene in toluene with no Di-tert-amyl peroxide was substituted for a solution including 0.05M Di-tert-amyl peroxide and 0.75M styrene in toluene.

### Example 6

### Treatment of Deuterium-Terminated Diamond Powder with Di-tert-amyl Peroxide, Styrene, and DVB

The procedure described for Example 4 was essentially followed, with the exception that a solution including 0.05M Di-tert-amyl peroxide, 0.75M styrene, and 0.025M divinylbenzene (“DVB”) in toluene was substituted for a solution including 0.05M Di-tert-amyl peroxide and 0.75M styrene in toluene.

### Example 7

### Treatment of Deuterium-Terminated Diamond Powder with Styrene and DVB

The procedure described for Example 4 was essentially followed, with the exception that a solution including 0.75M styrene and 0.025M DVB in toluene with no Di-tert-amyl peroxide was substituted for a solution including 0.05M Di-tert-amyl peroxide and 0.75M styrene in toluene.

### Example 8

### Treatment of Deuterium-Terminated Diamond Powder with Di-tert-amyl Peroxide, MMA, and DVB

The procedure described for Example 4 was essentially followed, with the exception that a solution including 0.05M Di-tert-amyl peroxide, 0.4M methyl methacrylate (“MMA”), and 0.025M DVB in toluene was substituted for a solution including 0.05M Di-tert-amyl peroxide and 0.75M styrene in toluene.

### Surface Analysis of Peroxide and Monomer-Treated Diamond Powders

Table 2 shows the concentrations reagents used in treating each of the diamond powders in Examples 4-8.

TABLE 2
Examples 4-8; Concentrations of Reagents Used.

| | Di-tert-amyl peroxide | Styrene | MMA | DVB |
|---|---|---|---|---|
| Example | (M) | (M) | (M) | (M) |
| 4 | 0.05 | 0.75 | 0 | 0 |
| 5 | 0 | 0.75 | 0 | 0 |
| 6 | 0.05 | 0.75 | 0 | 0.025 |
| 7 | 0 | 0.75 | 0 | 0.025 |
| 8 | 0.05 | 0 | 0.4 | 0.025 |

ToF-SIMS of diamond powder treated with di-tert-amyl peroxide and styrene according to Example 4 showed numerous hydrocarbon peaks in the positive spectrum, including characteristic peaks that are substantially the same as peaks for standard polystyrene. The relative intensities of the characteristic peaks closely matched the peaks for standard polystyrene, indicating the presence of polystyrene on the diamond powder treated with di-tert-amyl peroxide and styrene. This was especially true for the higher mass region for the main characteristic peaks, such as 103, 105, 115, 117 and 128. In contrast, ToF-SIMS of deuterium-terminated diamond powder prepared according to Example 1 showed relatively few hydrocarbon peaks in the positive spectrum, with little but noise in the high mass region.

DRIFT spectroscopy of diamond powder treated with di-tert-amyl peroxide and styrene according to Example 4 showed C—H stretching peaks in the absorbance spectrum for an aromatic ring at 3000-3200 cm⁻¹ and for an alkyl chain at 2800-3000 cm⁻¹. In contrast, DRIFT spectroscopy of deuterium-terminated diamond powder prepared according to Example 1 did not show peaks for an aromatic ring at 3000-3200 cm⁻¹ or for an alkyl chain at 2800-3000 cm⁻¹. In addition, an IR spectrum obtained by DRIFT spectroscopy for diamond powder treated with di-tert-amyl peroxide and styrene according to Example 4 was compared with a standard IR spectrum for polystyrene Most of the peaks in the IR spectrum for diamond powder treated with di-tert-amyl peroxide and styrene closely matched peaks in the standard IR for polystyrene, including C—H stretch peaks for an aromatic ring at 3000-3200 cm⁻¹, an alkyl chain at 2800-3000 cm⁻¹, and a peak for monobenzene at 700 cm⁻¹, as well as additional characteristic peaks at 1375 cm⁻¹, 1550 cm⁻¹, and 1650 cm⁻¹.

For the reaction of deuterium-terminated diamond powder prepared with styrene, but without peroxide, according to Example 5, DRIFT spectroscopy showed no characteristic polystyrene peaks, indicating that styrene had not polymerized on the diamond powder.

Positive ion ToF-SIMS spectra for diamond powder treated with di-tert-amyl peroxide, styrene, and DVB according to Example 6 showed characteristic peaks for polystyrene.

DRIFT spectroscopy of diamond powder treated with di-tert-amyl peroxide, styrene, and DVB according to Example 6 showed C—H stretch peaks for an aromatic ring at 3000-3200 cm⁻¹ and for an alkyl chain at 2800-3000 cm⁻¹, which peaks are both larger than those for diamond powder treated with di-tert-amyl peroxide and styrene according to Example 4. DRIFT spectroscopy of diamond powder treated with di-tert-amyl peroxide, styrene, and DVB also showed peaks at 1375 cm⁻¹, 1550 cm⁻¹, and 1650 cm⁻¹.

For the reaction of deuterium-terminated diamond powder prepared with styrene and DVB, but without peroxide, according to Example 7, DRIFT spectroscopy showed no characteristic polystyrene peaks, indicating that styrene had not polymerized on the diamond powder.

XPS results of diamond powder treated with di-tert-amyl peroxide, MMA, and DVB according to Example 8 showed that an oxygen signal was increased in comparison with a deuterium-terminated diamond powder prepared according to Example 1. The oxygen signal was also larger than an oxygen signal for each of Examples 4-7. This increase in surface oxygen is consistent with chemisorption of radicals from di-tert-amyl peroxide and chemisorption of MMA.

DRIFT spectroscopy of diamond powder treated with di-tert-amyl peroxide, MMA, and DVB according to Example 8 showed a vibrational band of C═O at 1740 cm⁻¹. In addition, DRIFT spectroscopy of the diamond powder treated with di-tert-amyl peroxide, MMA, and DVB substantially matched an infrared spectra for PMMA at most characteristic peaks. These results indicate that the monomer MMA polymerized on the diamond surfaces by radical addition to form PMMA.

The above results for Examples 4 and 6 indicate that di-tert-amyl peroxide abstracted deuterium atoms from surfaces of deuterium-terminated diamond powder to produce radicals on the diamond surfaces, and subsequently, styrene polymerized on the diamond powder surfaces through radical addition at the radical sites to produce polystyrene. Additionally, the above results for Example 8 indicate that di-tert-amyl peroxide abstracted deuterium atoms from surfaces of deuterium-terminated diamond powder to produce radicals on the diamond surfaces, and subsequently, MMA polymerized on the diamond powder surfaces through radical addition at the radical sites to produce PMMA. The above results for Examples 5 and 7 also indicate that styrene did not polymerize on the diamond powder surfaces that were not exposed to a peroxide, such as di-tert-butyl peroxide, likely due to a lack of radical sites formed on the surfaces of the diamond powder.

### Example 9

### Preparation of Hydrogen-Terminated Silicon Wafer

Silicon wafers were hydrogen terminated using a fluoride-ion etch. For Si(111) surfaces, 40% NH₄F (aq.) was used. For Si(100), 10% HF (aq.) was employed. Unless otherwise specified, all experiments were performed with Si(100). Prior to hydrogen termination, the silicon wafers were rinsed sequentially with toluene, isopropanol, and water and then subjected to air plasma cleaning for 10 minutes (Harrick Plasma Cleaner Model PDC-326, 110 V). Native oxide on the silicon wafer surface was then etched for 8 minutes with a fluoride ion etch to produce hydrogen-terminated silicon. The wafers were then rinsed briefly with distilled water and dried with a jet of nitrogen gas. The wafers were hydrophilic after plasma cleaning and hydrophobic after fluoride ion etching. Newly etched surfaces were used immediately in the following examples to prevent oxidation due to extended exposure to air.

### Examples 10-24

### Treatment of Hydrogen-Terminated Silicon Wafers with Peroxides and Monomers

For each of Examples 10-24, a reaction solution including a radical initiator, a monomer, and/or a crosslinking agent in toluene was prepared. The molar amounts for the radical initiator, monomer, and crosslinking agent for each of Examples 10-24 are shown in Table 3. Benzoyl peroxide (“BPO”) was used as the radical initiator in each of Examples 10-24. Either methyl methacrylate (“MMA”) or styrene was used as the monomer in the examples. Additionally, either divinylbenzene (“DVB”) or 1,3-butanediol diacrylate (“1,3 BDDA”) was used as the crosslinking agent in the examples.

TABLE 3
Examples 10-24; Concentrations of Reagents Used and Resulting Layer thickness.

| | | | | | | | Polymer Film |
|---|---|---|---|---|---|---|---|
| | | | MMA | Styrene | DVB | BDDA | Thickness |
| Example | Substrate | BPO (M) | (M) | (M) | (M) | (M) | (nm) |
| 10 | Si(100) | 0.05 | 0.5 | 0 | 0 | 0 | 1.8 |
| 11 | Si(100) | 0.05 | 0.8 | 0 | 0 | 0 | 1.8, 2.8, 3.0, |
| | | | | | | | 5.2 |
| 12 | Si(100) | 0.01 | 1.5 | 0 | 0 | 0 | 1.8 |
| 13 | Si(100) | 0.05 | 1.5 | 0 | 0 | 0 | 1.3 |
| 14 | Si(100) | 0.10 | 1.5 | 0 | 0 | 0 | 1.3 |
| 15 | Si(100) | 0.05 | 1.7 | 0 | 0 | 0 | 1.8, 2.7 |
| 16 | Si(100) | 0.05 | 3.0 | 0 | 0 | 0 | 1.4 |
| 17 | Si(111) | 0.05 | 0 | 0 | 0.05 | 0 | 2.7, 2.8, 3.1 |
| 18 | Si(111) | 0.05 | 0.81 | 0 | 0.05 | 0 | 6.0, 11.5, |
| | | | | | | | 10.1, 13.2, |
| | | | | | | | 15.7 |
| 19 | Si(111) | 0.05 | 0 | 1.5 | 0 | 0 | 3.43 |
| 20 | Si(111) | 0.05 | 0 | 1.3 | 0.083 | 0 | 9.80 |
| 21 | Si(111) | 0.05 | 0 | 1.5 | 0.050 | 0 | 10.73 |
| 22 | Si(111) | 0.05 | 0 | 1.5 | 0.10 | 0 | 12.65 |
| 23 | Si(100) | 0.05 | 0 | 0 | 0 | 0.052 | 2.5, 2.7 |
| 24 | Si(100) | 0.05 | 0.64 | 0 | 0 | 0.052 | 6.2, 7.1 |

For each of Examples 10-24, the solution was bubbled with nitrogen for 30 minutes, after which hydrogen-terminated silicon wafers prepared according to Example 9 and control wafers (native oxide coated silicon) were introduced into the solution. Toluene is a suitable solvent for radical polymerizations with MMA and methyl acrylate (“MA”) because of its small-chain transfer constant. Following introduction of the silicon wafers into the solution, the temperature of the solution was raised to 70° C., at which temperature benzoyl peroxide has a 10 hour half-life. The solution was maintained at 70° C. for 20 hours with stirring under a reflux condenser and continuously purged with a gentle stream of nitrogen gas over the surface of the solution. The silicon wafers were then removed from the solution, rinsed sequentially with toluene, isopropanol, and water, dried with a jet of nitrogen, and then placed overnight in a Soxhlet extractor with recirculating xylenes. Xylenes are an effective degreaser and were used to remove unbound or loosely bound material from the treated silicon wafers. The silicon wafers were then brushed with 2% sodium dodecylsulfate in water for 1 minute using a fine-bristled artist's brush.

### Surface Analysis of Peroxide and Monomer-Treated Silicon Wafers

In Examples 10-16, MMA concentration in the reaction solutions was varied between 0.5 M and 3.0 M, and BPO concentration was varied between 0.01 M and 0.10 M (see Table 3). An increase in film thickness on the surface of the silicon wafers of between 1.3 and 5.2 nm was observed by spectroscopic ellipsometry for Examples 10-16.

In Example 17, DVB and BPO were present in the reaction solution without MMA, resulting in polymer films having a thickness of 2.7-3.1 nm on the silicon substrates.

In Example 18, a reaction solution having DVB in addition to MMA allowed thicker polymer films to be grown on the silicon surfaces in comparison with Examples 10-16, which did not include DVB (see Table 3). In Example 18′ both DVB and MMA were present in the reaction solution with BPO, resulting in polymer films having a thickness of 6.0-15.7 nm on the silicon substrates.

In Examples 19-22, styrene was used in the reaction solutions as a monomer instead of MMA. In Example 19, a reaction solution including styrene but not DVB resulted in a polymer film having a thickness of 3.43 nm on the silicon substrate. In Examples 20-22, both DVB and styrene were present in the reaction solutions with BPO, resulting in polymer films having a thickness of 9.80-12.65 nm on the silicon substrates, indicating that the addition of a relatively small amount of DVB to the reaction solution allowed significantly thicker polymer films to be obtained.

In Examples 23-24, 1,3-butanediol diacrylate (“1,3 BDDA”) was substituted for DVB. In Example 23, 1,3 BDDA and BPO were present in a reaction solution without MMA, resulting in polymer films having a thickness of 2.5-2.7 nm. In contrast, in Example 24, both 1,3 BDDA and MMA were present in a reaction solution with BPO, resulting in polymer films having a thickness of 6.2-7.1 nm.

The above results indicate that a reaction solution including BPO and either styrene and/or MMA, formed a film including a few monolayers of an unsaturated monomer bound as a polymer to a hydrogen-terminated silicon surface in a single step reaction. The above results also indicate that a reaction solution including a BPO, styrene and/or MMA, and DVB and/or 1,3 BDDA, may form a film having a substantially greater thickness than a reaction solution without either DVB or 1,3 BDDA.

XPS surface analysis of film surfaces formed on silicon wafers using a reaction solution including MMA alone in comparison with film surfaces formed on silicon wafers using a reaction solution including MMA and DVB indicated that DVB likely facilitated thicker film growth of the MMA units on the silicon surfaces without DVB forming a principal component of the resulting film.

### Example 25

### Treatment of Silicon Wafers with BPO, MA, and DVB

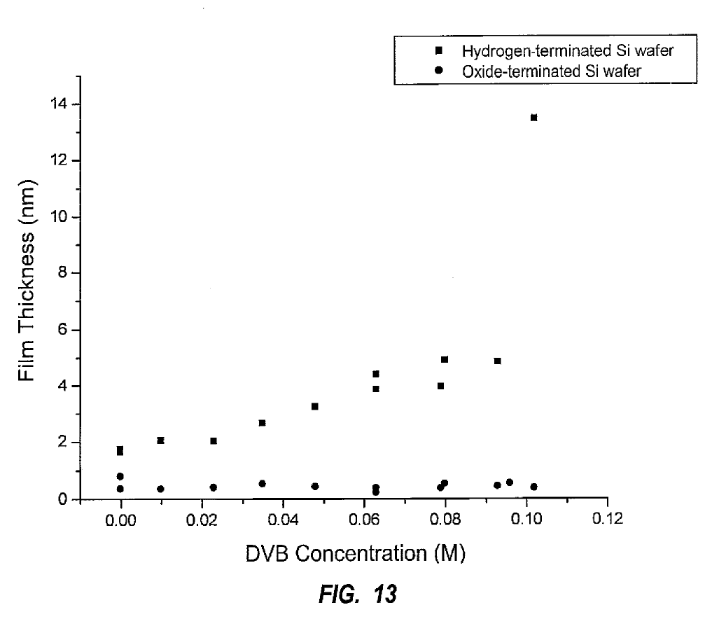

For each data point in FIG. 13, hydrogen-terminated silicon wafers prepared according to Example 9 and clean oxide-terminated silicon wafers were introduced into a toluene solution comprising 1.5M methylacrylate (“MA”), 0.05M BPO, and various concentrations of DVB as shown in this figure. Following introduction of the silicon wafers into the solution, the temperature of the solution was raised to 70° C., at which temperature benzoyl peroxide has a 10 hour half-life. The solution was maintained at 70° C. for 20 hours with stirring under a reflux condenser, and was continuously purged with a gentle stream of nitrogen gas over the surface of the solution. The silicon wafers were then removed from the solution, rinsed sequentially with toluene, isopropanol, and water, dried with a jet of nitrogen, and then placed overnight in a Soxhlet extractor with recirculating xylenes. Xylenes are an effective degreaser and were used to remove unbound or loosely bound material from the treated silicon wafers. The silicon wafers were then brushed with 2% sodium dodecylsulfate in water for 1 minute using a fine bristled artist's brush.

FIG. 13 clearly shows that polymer film growth occurred in an effective and controllable manner on the hydrogen-terminated silicon wafers. In contrast, FIG. 13 shows that no polymer film growth occurred on the oxide-terminated silicon wafers. A small amount of material that was observed on the surface of the oxide-terminated silicon wafers after reaction was presumably due to physisorbtion of hydrocarbons, which readily adsorb onto the high free-energy surface of the oxide-terminated silicon and may be difficult to remove without harsh cleaning methods, such a piranha solution or plasma cleaning.

### Example 26

### Preparation of Sulfonated Diamond Powder

A solution including 0.05M Di-tert-amyl peroxide, 0.75M styrene, and 0.025M DVB in toluene was prepared. The solution was bubbled with nitrogen for 30 minutes, after which 3 g of deuterium-terminated diamond powder prepared according to Example 1 was introduced to the solution. Toluene is a suitable solvent for radical polymerizations because of its small-chain transfer constant. Following introduction of the deuterium-terminated diamond powder, the temperature of the solution was raised to 110° C. The solution was maintained at 110° C. for 24 hours with stirring under a reflux condenser, and was continuously purged with a gentle stream of nitrogen gas over the surface of the solution.

The diamond powder was then treated in 5 mL acetic acid in an ice bath followed by 50 mL concentrated sulfuric acid. The mixture was subsequently heated to 90° C. for 5 hours to sulfonate the diamond powder. XPS of the sulfonated diamond powder prepared according to this example showed a significant oxygen signal as well as a sulfur signal, indicating the presence of oxygen and sulfur on the surface of the sulfonated diamond powder. In particular, XPS showed composition amounts for the sulfonated diamond powder prepared according to this example of 81.3% carbon, 15.8% oxygen, and 3.0% sulfur.

### Example 27

### Preparation and Testing of SPE Column Including Sulfonated Diamond Powder Stationary Phase

A sulfonated diamond powder prepared according to Example 26 was used as a stationary phase in this example. The stationary phase was packed into a strong cation-exchange SPE column. The column was conditioned with 6 column volumes of methanol followed by 6 column volumes phosphate buffer (H₃PO₄ and NaH₂PO₄, pH=1.9). The analyte used in this example was 1-naphthylamine (molecular weight: 143.1).

1-naphthylamine was loaded into the column by depositing a 0.05 mL sample of 1-naphthylamine dissolved in a buffer solution (pH=1.9) (1 mg/mL). Then 3 column volumes of the same buffer solution (pH=1.9) without 1-naphthylamine were flowed through the column. 1-naphthylamine did not elute from the column when the 3 column volumes of the buffer solution were flowed through the column, but rather, 1-naphthylamine was retained by the column. Finally, the 1-naphthylamine was eluted with a buffer solution that additionally included dissolved sodium chloride (pH=1.9, ionic strength is 0.2M). All of the fractions eluting from the column were analyzed by electrospray ionization mass spectroscopy.

Breakthrough curves were obtained for a column prepared according to this example. 1-naphthylamine was used as an analyte for determination of a breakthrough volume for the column. The column was conditioned with 6 column volumes of methanol followed by 6 column volumes of phosphate buffer (H₃PO₄ and NaH₂PO₄, pH=1.9). A solution of 1-naphthylamine dissolved in a buffer solution (pH=1.9) (0.01 mg/mL) was flowed through the column at a constant flow rate while the breakthrough curve was being obtained. Equal volumes of the fractions eluting from the column were collected in separate vials. The samples were then analyzed using electrospray ionization mass spectrometry to obtain breakthrough curves based on the presence of 1-naphthylamine in the collected fractions. The breakthrough volume was taken from the point on the breakthrough curves corresponding to 5% of the average value at the maximum (i.e., the breakthrough curve plateau region). From these breakthrough curves, a column capacity for the column including a sulfonated powder prepared according to Example 26 was found to be 0.08 mg.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative and not restrictive and that reference be made to the appended claims and their equivalents for determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

1-30. (canceled)

31. A stationary phase, comprising:
a plurality of diamond bodies, wherein at least one diamond body is at least partially hydrogen-terminated;
at least one polymeric compound covalently bonded to at least a portion of the at least one diamond body;
wherein at least a portion of the at least one polymeric compound is crosslinked.

32. The stationary phase of claim 31, wherein the at least one polymeric compound comprises a polymeric compound formed from at least one of a monofunctional monomer and a polyfunctional monomer.

33. The stationary phase of claim 31, wherein at least one of the plurality of diamond bodies is porous.

34. The stationary phase of claim 31, wherein the at least one polymeric compound comprises a polymeric compound formed from at least one of styrene, methyl acrylate, stearyl acrylate, methyl methacrylate, 2-hydroxyethylmethacrylate, acrylonitrile, methylacrylonitrile, acrylic acid, methacrylic acid, acrylamide, 2-isocyanatoethyl methacrylate, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, 2-(tert-butylamino)ethyl methacrylate, 1,3-butadiene, isoprene, vinyl chloride, butyl acrylate, dodecyl methacrylate, 4-vinylbenzyl chloride, maleimide, maleic anhydride, 4-(trifluoromethyl)styrene, 3-nitrostyrene, vinyl ether, and vinyl acetate.

35. The stationary phase of claim 31, wherein the at least one polymeric compound comprises a polymeric compound formed from at least one of divinylbenzene, 1,3-butanediol diacrylate, 1,4-butanediol diacrylate, pentaerythritol triacrylate, pentaerythritol tetraacrylate, dipentaerythritol pentaacrylate, 1,6-hexanediol dimethacrylate, and propoxylated (3) glyceryl triacrylate.

36. The stationary phase of claim 31, wherein the at least one polymeric compound comprises at least one of polystyrene, polyacrylonitrile, polymethacrylate, polyacrylamide, and polyacrylate.

37. The stationary phase of claim 36, wherein the at least one polymeric compound comprises at least one of a homopolymer and a copolymer.

38. A separation apparatus comprising the stationary phase of claim 36.

39. A particle comprising:
diamond that is at least partially hydrogen-terminated;
at least one polymeric compound covalently bonded to at least a portion of the diamond;
wherein at least a portion of the at least one polymeric compound is crossliniked.

40. The particle of claim 39, wherein the at least one polymeric compound comprises a polymeric compound formed from at least one of a monofunctional monomer and a polyfunctional monomer.

41. The particle of claim 39, wherein the diamond is porous.

42. The particle of claim 39, wherein the at least one polymeric compound comprises a polymeric compound formed from at least one of styrene, methyl acrylate, stearyl acrylate, methyl methacrylate, 2-hydroxyethylmethacrylate, acrylonitrile, methylacrylonitrile, acrylic acid, methacrylic acid, acrylamide, 2-isocyanatoethyl methacrylate, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, 2-(tert-butylamino)ethyl methacrylate, 1,3-butadiene, isoprene, vinyl chloride, butyl acrylate, dodecyl methacrylate, 4-vinylbenzyl chloride, maleimide, maleic anhydride, 4-(trifluoromethyl)styrene, 3-nitrostyrene, vinyl ether, and vinyl acetate.

43. The particle of claim 39, wherein the at least one polymeric compound comprises a polymeric compound formed from at least one of divinylbenzene, 1,3-butanediol diacrylate, 1,4-butanediol diacrylate, pentaerythritol triacrylate, pentaerythritol tetraacrylate, dipentaerythritol pentaacrylate, 1,6-hexanediol dimethacrylate, and propoxylated (3) glyceryl triacrylate.

44. The particle of claim 39, wherein the at least one polymeric compound comprises at least one of polystyrene, polyacrylonitrile, polymethacrylate, polyacrylamide, and polyacrylate.

45. The particle of claim 44, wherein the at least one polymeric compound comprises at least one of a homopolymer and a copolymer.

46. A separation apparatus comprising a stationary phase that includes a plurality of the particles of claim 39.
